(19) United States
(12) Patent Application Publication
(10) Pub. No.: US 2002/0103713 A1
(43) Pub. Date: Aug. 1, 2002

(54) Method of ordering products over the Internet from a central bureau interacting with diversely located and pre-existing member retailers

(76) Inventor: Kwon Su Kim, New City, NY (US)

Correspondence Address: Kwon Su Kim, One Cosmos Lane, New City, NY, 10956, US

(21) Appl. No.: 09/769,819

(22) Filed: Jan. 26, 2001

(51) Int. Cl. G06F 17/60

(52) U.S. Cl. 705/26

(57) ABSTRACT

A method of ordering a variety of diversified products over the Internet from a central bureau carrying no inventories and making no deliveries but interacting with diversely located and pre-existing satellite member retailers carrying the inventories and making the deliveries so as to establish a pre-arranged network of member retailers now having an opportunity to compete with Internet retailers. A consumer orders a product over the Internet from the interactive website of the central bureau to be delivered to a specific destination. The central bureau locates the member retailer most closest to the specific destination and delegates the order thereto to be filled and delivered to the specific destination.

### BACKGROUND OF THE INVENTION

1. Field of the Invention

The present invention relates to a method of ordering a variety of diversified products over the Internet. More particularly, the present invention relates to a method of ordering a variety of diversified products over the Internet from a central bureau having no inventories and making no deliveries, but interacting with diversely located and pre-existing member retailers having the inventories and making the deliveries.

2. Description of the Prior Art

Numerous innovations for shopping systems have been provided in the prior art that will be described. Even though these innovations may be suitable for the specific individual purposes to which they address, however, they differ from the present invention in that they do not teach a method of ordering a variety of diversified products over the Internet from a central bureau having no inventories and making no deliveries, but interacting with diversely located and pre-existing member retailers having the inventories and making the deliveries.

FOR EXAMPLE, U.S. Pat. No. 4,971,406 to Hanson teaches an exemplary data entry terminal. The keyboard, display module, and terminal processor board form respective subassemblies which can readily be disconnected from each other electrically and slidably removed from respective channels of a U-shaped housing extrusion. A cathode ray tube of the display module may be viewed through a window forming part of the keyboard subassembly. In the case of a pizza home delivery system, bar codes identifying the orders are printed out for facilitating handling, and order handling and delivery are computerized for optimum speed and accuracy.

ANOTHER EXAMPLE, U.S. Pat. No. 5,890,137 to Koreeda teaches a system for performing on-line shopping using the Internet. When performing payment settlement for a product by a credit card, user's card data runs over the Internet, leaving the possibility of card data leakage, thereby causing a security problem. The user decides the product he or she wants to buy via a computer network (Internet) from a user system. Then, a transmission unit calls up a service center to send order data including the credit card data via a settlement network. A service center invoices the sales price to an approval center based on the order data. The approval center pays the price to service center. Then, service center sends the order data to the shopping system. A delivery processing unit then delivers the product to the user based on the order data.

STILL ANOTHER EXAMPLE, U.S. Pat. No. 5,991,739 to Cupps et al. teaches a system and method for providing an online ordering machine that manages the distribution of home delivered products over a distributed computer system is herein disclosed. The distributed computer system includes a group of customers connected to client computers and at least one server computer system that executes the online ordering machine. The online ordering machine provides the customers with product information from various vendors whose delivery range is within the customer's location or with product information from vendors having take out service within a specified range from the customer's location. The vendor's and customer's location is associated with a geocode representing the latitude and longitude coordinates of the location. The search for the vendors servicing the customer's location is done using the geocodes. The online ordering machine accepts orders from the customer for a particular product from a selected vendor. The order is converted into voice instructions which are transmitted to the vendor through a telephone call. The vendor receives the telephonic order and responds to voice-prompted instructions used to confirm the order.

YET ANOTHER EXAMPLE, U.S. Pat. No. 5,334,824 to Martinez teaches a method and apparatus for delivering an order to a home and utilizing credit information to verify and accept payment for the order. The method and apparatus verify credit information on site at the door of a home contemporaneously with delivery of an order.

STILL YET ANOTHER EXAMPLE, U.S. Pat. No. 6,026,376 to Kenney teaches an interactive electronic shopping system and method to create a virtual shopping facility from an actual shopping facility, such as a grocery store, restaurant, or office. A shopper at a computer or other suitable display device can move through the virtual shopping facility and see replicas of what would be seen in moving through the actual shopping facility. Various lists of items selected for purchase can be made, and predetermined lists and information can be displayed. Changes in the actual shopping facility, such as a change in a display of goods, can be accommodated by replacing prior data with new data so that the virtual shopping environment is kept current with the actual shopping facility.

YET STILL ANOTHER EXAMPLE, U.S. Pat. No. 6,028,940 to Tanaka et al. teaches a computer network system that includes a first computer of a first corporation having a plurality of member shops and a second computer of a second corporation which is the member shop of the first corporation and runs a virtual shop on a network. The first computer includes a memory for storing display information indicating that a corresponding shop is the member shop of the first corporation, a memory for storing encryption information for encrypting the display information, and an output section for encrypting the display information by the encryption information and outputting the encrypted display information. The second computer includes a reception section for receiving the encrypted display information through the communication line, and a memory for storing the received encrypted display information.

It is apparent that numerous innovations for shopping systems have been provided in the prior art that are adapted to be used. Furthermore, even though these innovations may be suitable for the specific individual purposes to which they address, however, they would not be suitable for the purposes of the present invention as heretofore described.

### SUMMARY OF THE INVENTION

ACCORDINGLY, AN OBJECT of the present invention is to provide a method of ordering a variety of diversified products over the Internet from a central bureau having no inventories and making no deliveries, but interacting with diversely located and pre-existing member retailers having the inventories and making the deliveries that avoids the disadvantages of the prior art.

ANOTHER OBJECT of the present invention is to provide a method of ordering a variety of diversified products over the Internet from a central bureau having no inventories and making no deliveries, but interacting with diversely located and pre-existing member retailers having the inventories and making the deliveries that is simple and inexpensive to manufacture.

STILL ANOTHER OBJECT of the present invention is to provide a method of ordering a variety of diversified products over the Internet from a central bureau having no inventories and making no deliveries, but interacting with diversely located and pre-existing member retailers having the inventories and making the deliveries that is simple to use.

BRIEFLY STATED, YET ANOTHER OBJECT of the present invention is to provide a method of ordering a variety of diversified products over the Internet from a central bureau carrying no inventories and making no deliveries but interacting with diversely located and pre-existing satellite member retailers carrying the inventories and making the deliveries so as to establish a pre-arranged network of member retailers now having an opportunity to compete with Internet retailers. A consumer orders a product over the Internet from the interactive website of the central bureau to be delivered to a specific destination. The central bureau locates the member retailer most closest to the specific destination and delegates the order thereto to be filled and delivered to the specific destination.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIGS. 1A-1G are a process flow diagram of the present invention.

### LIST OF REFERENCE NUMERALS UTILIZED IN THE DRAWING

10 method of ordering a variety of diversified products over the Internet from a central bureau carrying no inventories and making no deliveries but interacting with diversely located and pre-existing satellite member retailers carrying the inventories and making the deliveries

12 central bureau

14 interactive website of central bureau 12

16 database of central bureau 12

18 diversely located and pre-existing retailers

20 contract

22 pre-arranged network of member retailers

24 Internet retailers

26 guidelines

28 inventories

30 geographic area

32 profit

34 consumer

36 product

37 Internet

38 specific destination

39 zip code of specific destination 38

40 order

42 credit card

44 COD

46 closest member retailer

48 delivery

50 customer service

### DETAILED DESCRIPTION OF THE PREFERRED EMBODIMENT

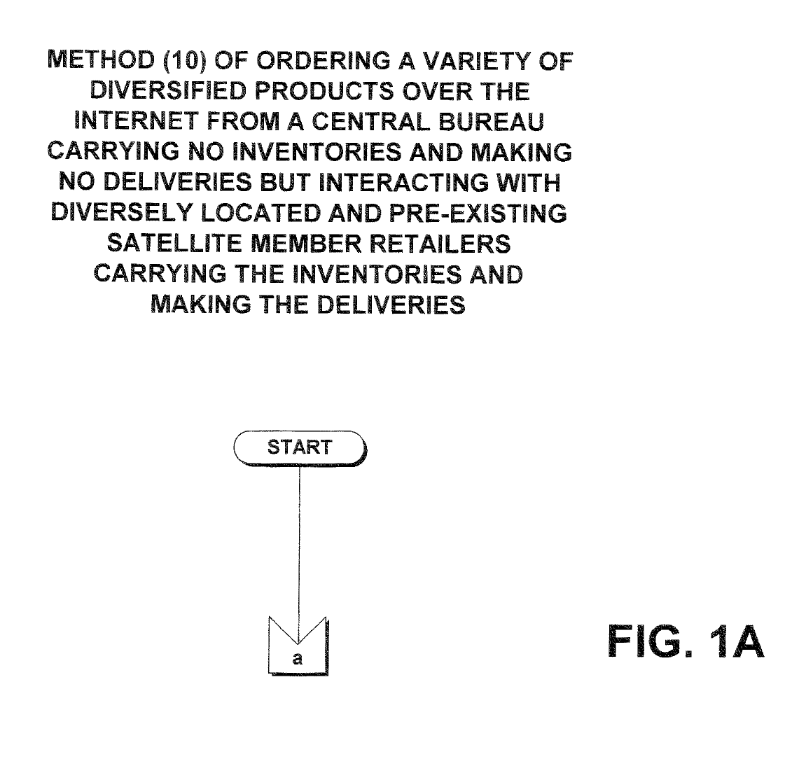

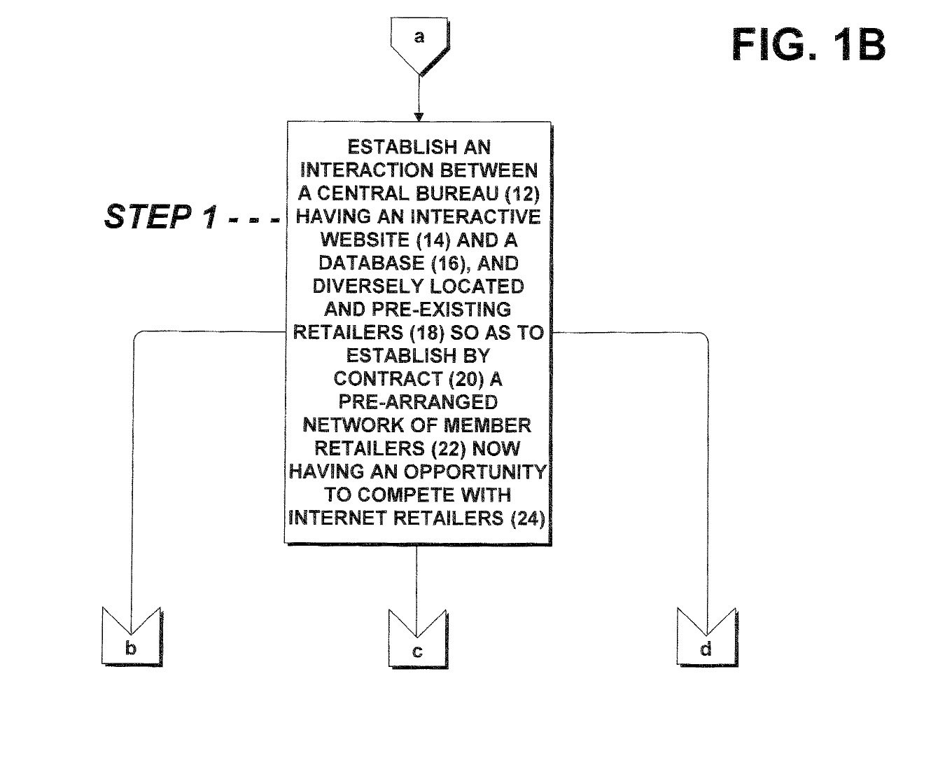

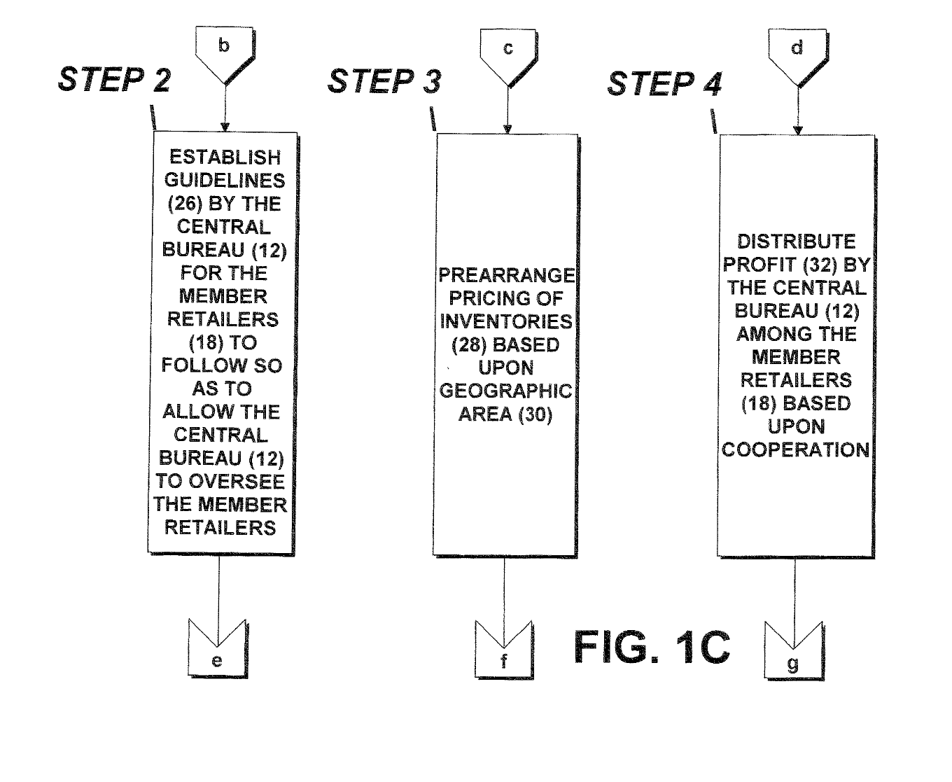

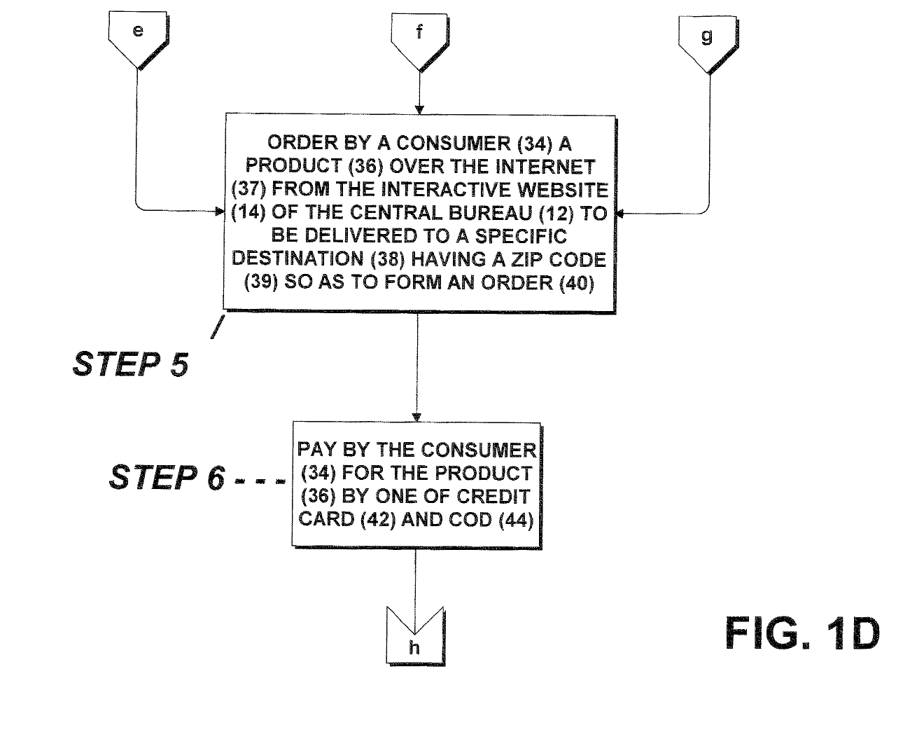

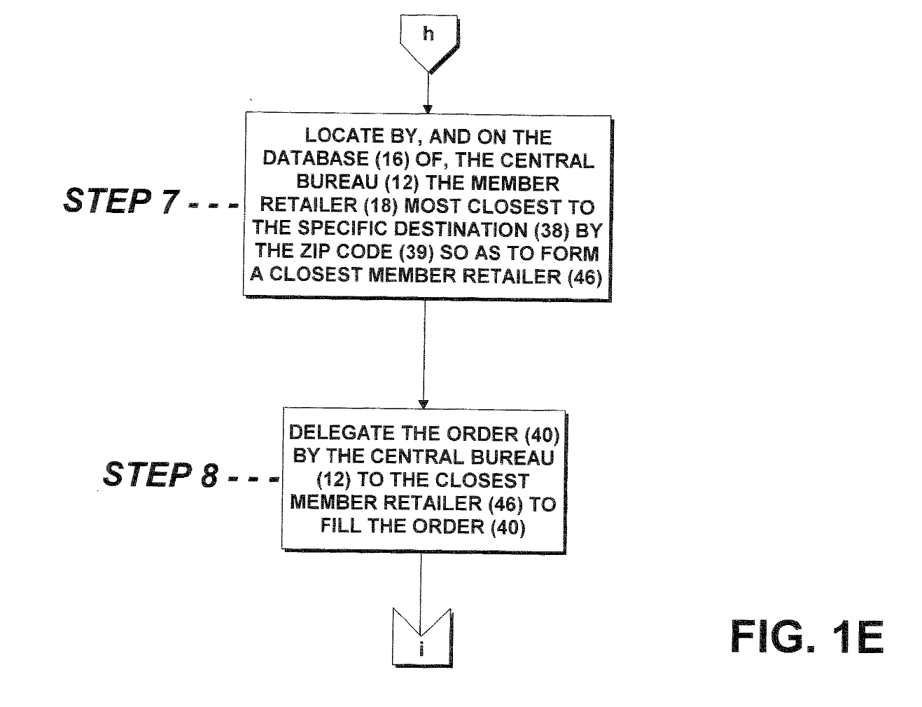

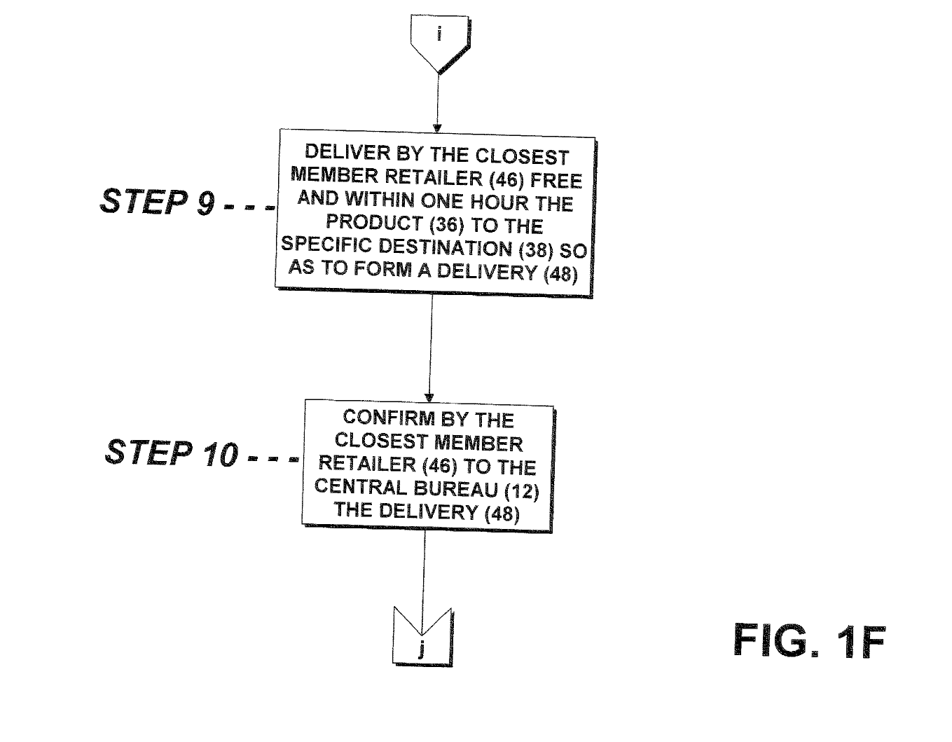

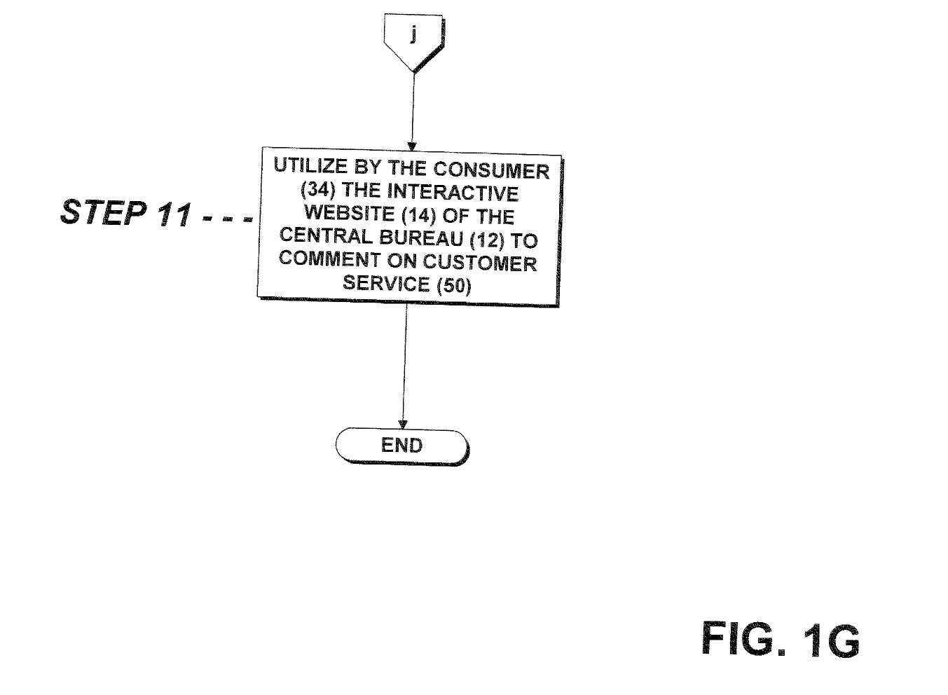

Referring now to the figures, in which like numerals indicate like parts, and particularly to FIGS. 1A-1G, which are a process flow diagram of the present invention, the method of ordering a variety of diversified products over the Internet from a central bureau carrying no inventories and making no deliveries but interacting with diversely located and pre-existing satellite member retailers carrying the inventories and making the deliveries of the present invention is shown generally at 10.

The method of ordering a variety of diversified products over the Internet from a central bureau carrying no inventories and making no deliveries but interacting with diversely located and pre-existing satellite member retailers carrying the inventories and making the deliveries 10 comprises the steps of

STEP 1: Establish an interaction between a central bureau 12 having an interactive website 14 and a database 16, and diversely located and pre-existing retailers 18 so as to establish by contract 20 a pre-arranged network of member retailers 22 now having an opportunity to compete with Internet retailers 24.

STEP 2: Establish guidelines 26 by the central bureau 12 for the member retailers 18 to follow so as to allow the central bureau 12 to oversee the member retailers 18.

STEP 3: Pre-arrange pricing of inventories 28 based upon geographic area 30.

STEP 4: Distribute profit 32 by the central bureau 12 among the member retailers 18 based upon cooperation.

STEP 5: Order by a consumer 34 a product 36 over the Internet 37 from the interactive website 14 of the central bureau 12 to be delivered to a specific destination 38 having a zip code 39 so as to form an order 40.

STEP 6: Pay by the consumer 34 for the product 36 by one of credit card 42 and COD 44.

STEP 7: Locate by, and on the database 16 of, the central bureau 12 the member retailer 18 most closest to the specific destination 38 by the zip code 39 so as to form a closest member retailer 46.

STEP 8: Delegate the order 40 by the central bureau 12 to the closest member retailer 46 to fill the order 40.

STEP 9: Deliver by the closest member retailer 46 free and within one hour the product 36 to the specific destination 38 so as to form a delivery 48.

STEP 10: Confirm by the closest member retailer 46 to the central bureau 12 the delivery 48.

STEP 11: Utilize by the consumer 34 the interactive website 14 of the central bureau 12 to comment on customer service 50.

It will be understood that each of the elements described above, or two or more together, may also find a useful application in other types of constructions differing from the types described above.

While the invention has been illustrated and described as embodied in a method of ordering a variety of diversified products over the internet from a central bureau carrying no inventories and making no deliveries but interacting with diversely located and pre-existing satellite member retailers carrying the inventories and making the deliveries, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A method of ordering a variety of diversified products over the Internet from a central bureau carrying no inventories and making no deliveries but interacting with diversely located and pre-existing satellite member retailers carrying the inventories and making the deliveries, said method comprising the steps of:
a) establishing an interaction between a central bureau having an interactive website and a database, and diversely located and pre-existing retailers so as to establish by contract a pre-arranged network of member retailers now having an opportunity to compete with Internet retailers;
b) ordering by a consumer a product over the Internet from the interactive website of the central bureau to be delivered to a specific destination so as to form an order;
c) locating by, and on the database of, the central bureau the member retailer most closest to the specific destination so as to form a closest member retailer;
d) delegating the order by the central bureau to the closest member retailer to fill the order; and
e) delivering by the closest member retailer the product to the specific destination so as to form a delivery.

2. The method as defined in claim 1; further comprising the step of establishing guidelines by the central bureau for the member retailers to follow so as to allow the central bureau to oversee the member retailers.

3. The method as defined in claim 1; further comprising the step of pre-arranging pricing of inventories based upon geographic area.

4. The method as defined in claim 1; further comprising the step of distributing profit by the central bureau among the member retailers based upon cooperation.

5. The method as defined in claim 1; further comprising the step of paying by the consumer for the product by one of credit card and COD.

6. The method as defined in claim 1; further comprising the step of confirming by the closest member retailer to the central bureau the delivery.

7. The method as defined in claim 1; further comprising the step of utilizing by the consumer the interactive website of the central bureau to comment on customer service.

8. The method as defined in claim 1, wherein said step of establishing an interaction between a central bureau having an interactive website and a database, and diversely located and pre-existing retailers so as to establish a pre-arranged network of member retailers now having an opportunity to compete with Internet retailers includes establishing an interaction between a central bureau having an interactive website and a database but having no inventories and making no deliveries, and diversely located and pre-existing retailers having the inventories and making the deliveries so as to establish a pre-arranged network of member retailers now having an opportunity to compete with Internet retailers.

9. The method as defined in claim 1, wherein said step of establishing an interaction between a central bureau having an interactive website and a database, and diversely located and pre-existing retailers so as to establish a pre-arranged network of member retailers now having an opportunity to compete with Internet retailers includes establishing an interaction between a central bureau having an interactive website and a database, and diversely located and pre-existing retailers so as to establish by contract a pre-arranged network of member retailers now having an opportunity to compete with Internet retailers.

10. The method as defined in claim 1, wherein said steps of:
a) ordering by a consumer a product over the Internet from the interactive website of the central bureau to be delivered to a specific destination so as to form an order includes ordering by a consumer a product over the Internet from the interactive website of the central bureau to be delivered to a specific destination having a zip code so as to form an order; and
b) locating by, and on the database of, the central bureau the member retailer most closest to the specific destination so as to form a closest member retailer includes locating by, and on the database of, the central bureau the member retailer most closest to the specific destination by the zip code so as to form a closest member retailer.

11. The method as defined in claim 1, wherein said step of delivering by the closest member retailer the product to the specific destination so as to form a delivery includes delivering by the closest member retailer free and within one hour the product to the specific destination so as to form a delivery.
